(19) United States
(12) Patent Application Publication
(10) Pub. No.: US 2012/0158564 A1
(43) Pub. Date: Jun. 21, 2012

(54) SYSTEM AND METHOD FOR ACCOUNT MANAGEMENT BASED ON OPEN APPLICATION PROGRAMMING INTERFACE USING RESTFUL WEB SERVICES

(75) Inventors: Sun-Hwan Lim, Daejeon-si (KR); Hyun-Joo Bae, Daejeon-si (KR); Byung-Sun Lee, Daejeon-si (KR)

(73) Assignee: ELECTRONICS AND TELECOMMUNICATIONS RESEARCH INSTITUTE, Daejeon-si (KR)

(21) Appl. No.: 13/328,282

(22) Filed: Dec. 16, 2011

(30) Foreign Application Priority Data
Dec. 17, 2010 (KR) 10-2010-0130275

(51) Int. Cl. G06Q 30/04

(52) U.S. Cl. 705/35

(57) ABSTRACT

A Represental State Transfer (REST) based account management system and method is provided. The REST based account management system includes an open type service application server configured to provide an interface with respect to a client that uses a RESTful web service, manage an access right of the client and call an account management open type interface from an open type service gateway, the open type service gateway configured to provide the open type service application server with account management resources through a RESTful web service, and a billing server configured to charge the RESTful web service while interoperating with the open type service gateway.

### CROSS-REFERENCE TO RELATED APPLICATION

This application claims the benefit under 35 U.S.C. §119(a) of Korean Patent Application No. 10-2010-0130275, filed on Dec. 17, 2010, the disclosure of which is incorporated by reference in its entirety for all purposes.

### BACKGROUND

1. Field

The following description relates to a web service technology, and more particularly, to a technology for account management based on an open interface using RESTful web services.

2. Description of the Related Art

Open application programming interface (Open API) represents a standardized open interface between a communication service logic and a communication network. The Open API can provide an integrated service regardless of characteristics and configuration of a transport network corresponding to a lower layer. The Open API has been standardized into a Common Object Request Broker Architecture (CORBA) based Open API and a Simple Object

Access Protocol (SOAP) based Open API. Parlay has been incorporated into object management architecture (OMA) and interfaces are newly defined through a Represental State Transfer based web service (hereinafter, referred to as RESTful web service) in an OMA REST group such that the interfaces are easily invoked and used in an IT based application program. Accordingly, IT application developers lacking of detailed knowledge about a communication protocol can make an access to resources of a communication network with easy.

SOAP based web services have been started to satisfy the demand for interoperability between application services in a business environment, on the other hand, RESTful web services have been started such that internet service providers can offer easy use of data to application developers. The SOAP based web service has been developed in a complicated grammar that can be understood by programs (machines) providing and using services. Accordingly, in order to use the SOAP based web service, application developers need to have a high level of programming capability using a basic specification of web services. In recent years, various types of development environments have been provided for user's convenience in developing the SOAP based web services.

Meanwhile, the RESTful web service does not require additional development/execution environments besides default system elements for internet, such as HTTP and XML. In particular, the internet service provider of the RESTful web services provides internet services together with a Mash Up environment available on free.

### SUMMARY

In one aspect, there is provided a technology for account management based on an open Application Programming Interface (API) using RESTful web services.

In one general aspect, there is provided a system for account management based on Represental State Transfer (REST), the system including: an open type service application server configured to provide an interface with respect to a client that uses a RESTful web service, manage an access right of the client and call an account management open type interface from an open type service gateway; the open type service gateway configured to provide the open type service application server with account management resources through a RESTful web service; and a billing server configured to charge the RESTful web service while interoperating with the open type service gateway.

In another general aspect, there is provided a system for account management based on Represental State Transfer (REST), the system including: a RESTful web service client configured to manage an account balance by calling an account management resource of an open type service gateway, and if an account balance is changed, process an account subscription and notification by calling an account management subscription and notification resource of the open type service gateway; a RESTful web service server configured to operate an account management interface and an account management subscription and notification interface of the open type service gateway; and an interface configured to connect the open type service gateway to a billing server.

In another general aspect, there is provided an account management method in which an open type service application server requests an account balance inquiry from an open type service gateway and updates an account balance in a REST based environment, the method including; requesting the open type service gateway to inquire into an account balance by use of a GET method of an account balance resource; and receiving a result of the account balance inquiry having a resource URL (Uniform Resource Locator) from the open type service gateway.

In another general aspect, there is an account management method in which an open type service application server processes an account balance change by use of an open type service gateway in a REST based environment, the account management method including: requesting an account balance change notification subscription from the open type service gateway by use of a POST method of an account balance change notification subscription resource; and if the open type service gateway creates the account balance change notification subscription upon the request, receiving a result of the account balance change notification subscription having a subscription ID and a resource URL that are allocated by the open type service gateway.

In another general aspect, there is provided an account management method in which an open type service application server inquires into an account transaction history by use of an open type service gateway in a REST based environment, the account management method including: requesting the open type service gateway to inquire into an account transaction history by use of a GET method of an account transaction resource; and receiving a result of the inquiry of the account transaction history having a resource ULR from the open type service gateway.

As described above, an account management function required when a user purchases a product and a service through Internet is designed based on an Open interface that is openly put to use by a communication network operator. According to this example, when processing an account management function requested by an application server connected to an internet network, various kinds of account management functions can be easily processed in wired/wireless network by only use of an open interface using RESTful web services that is provided by the communication network operator.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 illustrates the configuration of an example of a system for account management using an open API using REST web services.

FIG. 2 illustrates an example of resources for an account management open type service of the system of FIG. 1.

FIG. 3 illustrates an example of a method for account balance inquiry and an account balance update for an account management open type service between an open type service application server and an open type service gateway in a REST based environment.

FIG. 4 illustrates an example of a method for account change notification between an open type service application server and an open type service gateway in a REST based environment.

FIG. 5 illustrates an example of a method for account transaction history inquiry between an open type service application server and an open type service gateway in a REST based environment.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

Hereinafter, examples will be described with reference to accompanying drawings in detail.

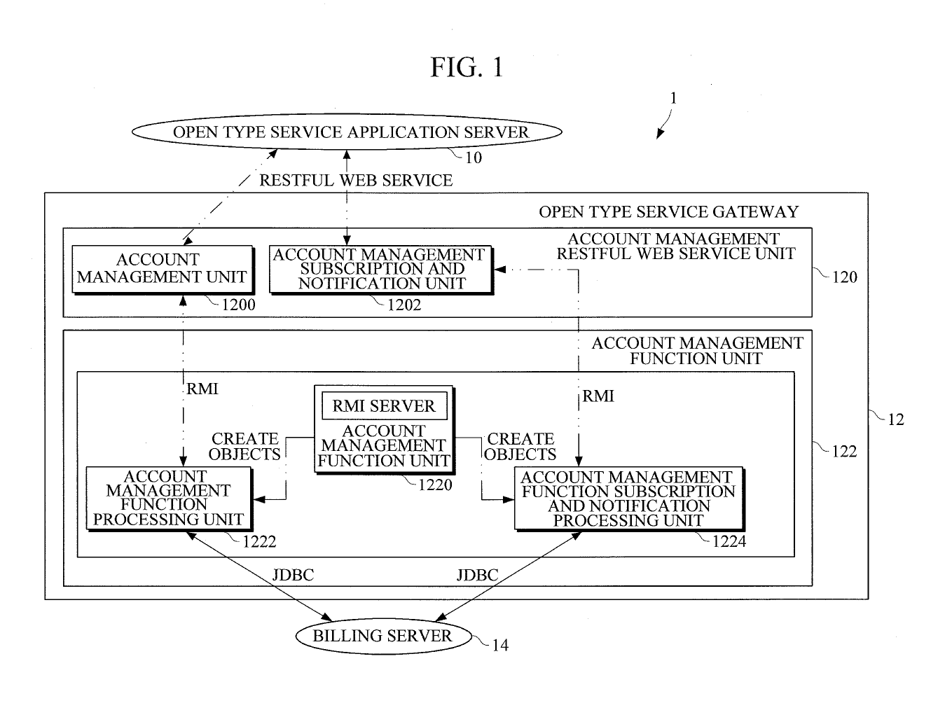

FIG. 1 illustrates the configuration of an example of an account management system 1 based on an open API using Represental State Transfer (REST) web services.

Referring to FIG. 1, when a user terminal purchases products and services through Internet, an open type service application server 10 calls an account management open type interface, thereby requesting an account management from a gateway, which uses an open type service API (application programming interface) that is provided by a communication network operator. To this end, the account management system 1 includes an application service logic including a website having a service user interface and an account management application program, an open type service gateway 12 of a communication network operator and a billing server 14 connected to the open type service gateway 12. The open type service gateway 12 allows the application service logic of the open type service application server 10 and account management resources to be openly used in the open type service application server 10 through RESTful web service. The account management system 1 may manage account balances of advanced payment card and deterred payment card, but is not limited thereto.

Represental State Transfer (REST) is a framework that enables data transfer through HTTP protocol without the addition of another layer or session management. In addition, the REST provides simple implementation of a system and improves the scalability and performance by separately implementing each component of a client and a server.

In recent years, the REST has been introduced to web application which attempt to achieve remote or local use of open resources that are open on web environments. RESTful web services represent services and applications that are defined and used according to the style of REST architecture. The resources represent all resource that are open to be shared with others on web, for example, web sites, blogs, images, music, users, map and search results. The resources based on the REST architecture have their own uniform resource locators (URL), and allows access only through basic methods of HTTP, such as GET/PUT/POST/DELETE.

A RESTful web service may represent resource based architectures (ROA) due to its resource based representation, transfer and access characteristics. ROA is regarded as a concept opposing to Service Oriented Architecture (SOA). That is, the RESTful web service is a service allowing access only with HTTP protocol regardless of the types of web server and web clients.

Hereinafter, an example of the account management system will be described in detail with reference to FIG. 1.

The open type service application server 10 provides an interface with respect to a client who uses RESTful web services and manages an access right of the client. The open type service application server 10 calls account management resources from the open type service gateway 12. The open type service gateway 12 provides the account management resources to the open type service application server 10 through RESTful web services. The billing server 15 charges the RESTful web service while interoperating with the open type service gateway 12.

The open type service gateway 12 includes an account management RESTful web service unit 120 and an account management function unit 122.

The account management RESTful web service unit 120 processes a REST message, which is received from the open type service application server 10, through an account management unit 1200 and an account management subscription and notification unit 1202, transmits the processed REST message to the account management function unit 122 and transmits a REST response message to the open type service application server 10.

The account management function unit 122 is configured to operate an account management interface and an account management subscription and notification interface. The account management function unit 122 includes an account management function control unit 1220, an account management function processing unit 1222 and an account management function subscription and notification processing unit 1224.

The account management function control unit 1220 is a main tread that exists all the time to serve as a main processor, and controls the account management function processing unit 1222 and the account management function subscription and notification processing unit 1224. In detail, the account management function control unit 1220 generates a Remote Method Invocation (RMI) server to process a RMI request made by the account management RESTful web service unit 120 and registers the generated RMI server in a RMI registry. Upon a request by the account management RESTful web service unit 120, the account management function control unit 1220 retrieves instances of the account management function processing unit 1222 and the account management function subscription and notification processing unit 1224.

The account management function processing unit 1222 operates an account management interface and interoperates with the billing server 14. That is, the account management function processing unit 1222 is generated by the RMI server of the account management function control unit 1220 and performs an operation of processing, returning and finishing one piece of information upon reception of one request. The account management function processing unit 1222 interoperates with the billing server 14 to perform an account management

The account management function subscription and notification processing unit 1224 performs an account management subscription and notification interface and interoperates with the billing server 14. That is, the account management function subscription and notification processing unit 1224 is generated by the RMI server of the account management function control unit 1220 and performs an operation of processing, returning and finishing one piece of information upon reception of one request. The account management function subscription and notification processing unit 1224 interoperates with the billing server 14 to notify the open type service application server 10 of a result of the account management.

Meanwhile, an example of the REST based account management system may be implemented in software manner. In this example, the REST based account management system includes a web site including an account management application program, a user management module that allows a user to subscribe and log-in a web site, a RESTful web service client program module configured to call an open type service gateway account management resource for account management, a RESTful web service server program module that performs an open type service gateway account management interface, an interface module configured to connect an account management function implementation module to a communication network internal billing server, and an account management providing program including a billing server.

In addition, an_example of a REST based account management system may include a RESTful web service client program module, a REST web service server program module, an interface module and a billing server. The RESTful web service client program module is configured to call account management subscription and notification resources of the open type service gateway such that an account balance change is reported to a service logic of an application of an open type service application server upon the occurrence of account balance change. The RESTful web service server program module is configured to operate an open type service gateway account management subscription and notification interface. The interface module is configured to connect an account management function subscription and notification implementation module to a communication network internal billing server.

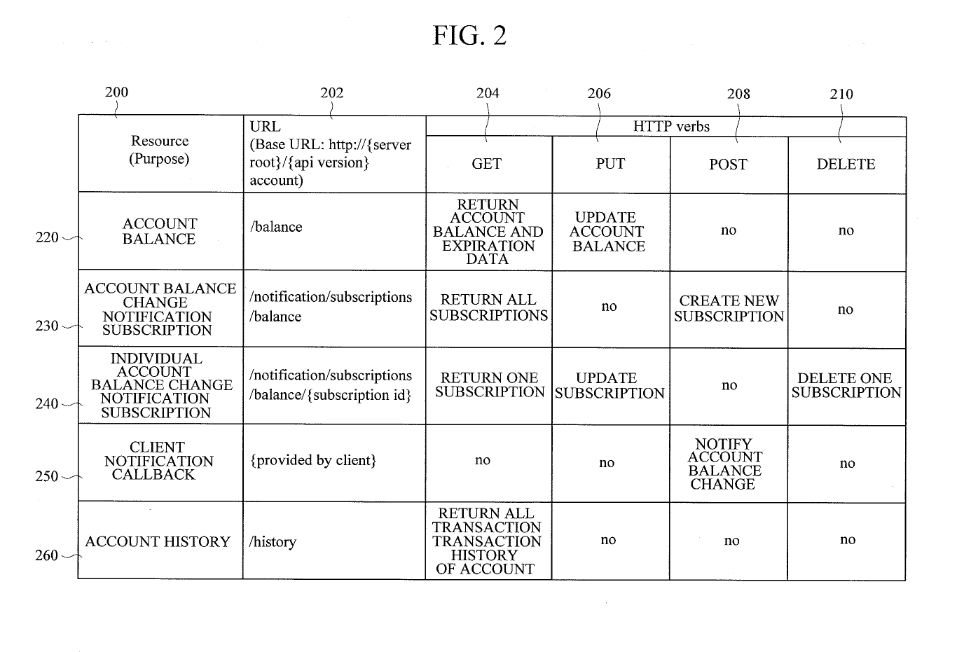

FIG. 2 illustrates an example of resources for an account management open type service of the system 1 of FIG. 1.

As shown in FIG. 2, an application service logic of the open type service application server 10 calls an account management interface by use of a resource 200 to request account management from the open type service gateway 12. The resource 200 includes Account Balance 220, Account Balance Change Notification Subscription 230, Individual Account Balance Change Notification Subscription 240, Client Notification Callback 250 and Account History 260. In the REST architecture, each resource 200 has its own URL 202 and allows access only through the basic methods of HTTP such as, GET(READ) 204, PUT(UPDATE) 206, POST(CREATE) 208 and DELETE 210.

The Account Balance resource 220 returns the account balance and the expiration data by use of the GET method 204, and updates the account balance by use of the PUT method 206.

The Account Balance Change Notification Subscription resource 230 returns all subscriptions, that is, all account balance change notification subscriptions, by use of the GET method 204 and creates a new subscription, that is, a new account balance change notification subscription by use of the POST method 208.

The Individual Account Balance Change Notification Subscription resource 240 returns one subscription, that is, one account balance change notification subscription by use of the GET method 204, updates subscription, that is, an account balance change notification subscription by use of the PUT method 206, and deletes one subscription by use of the DELETE method 210.

The Client Notification Callback resource 250 notifies an open type service application server of the change of account balance by use of the POST method 208, that is, notifies a client about new account balance change.

The Account History resource 260 returns the transaction history of the account by use of the GET method 204.

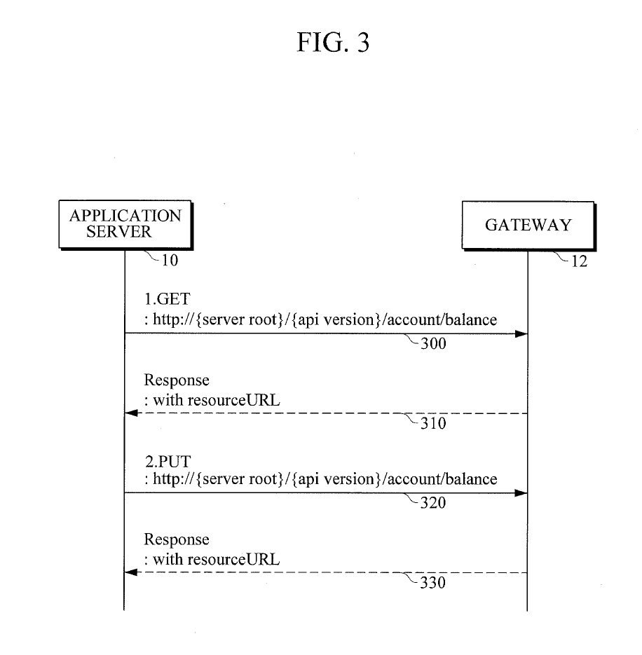

FIG. 3 illustrates an example of a method for account balance inquiry and an account balance update for an account management open type service between the open type service application server 10 and the open type service gateway 12 in a REST based environment.

As shown in FIG. 3, the application of the application server 10 requests the open type service gateway 12 to inquire into an account balance by use of the GET method of the account balance resource (300). Then, the application receives a result of account balance inquiry having a resource URL from the open type service gateway 12 (310). Thereafter, if there is a need for an account balance update, the application server 10 requests the gateway 12 to update the account balance by use of the PUT method of the account balance resource (320). As a result, the application server 10 receives a result of the account balance update having a resource URL from the open type service gateway 12 (330).

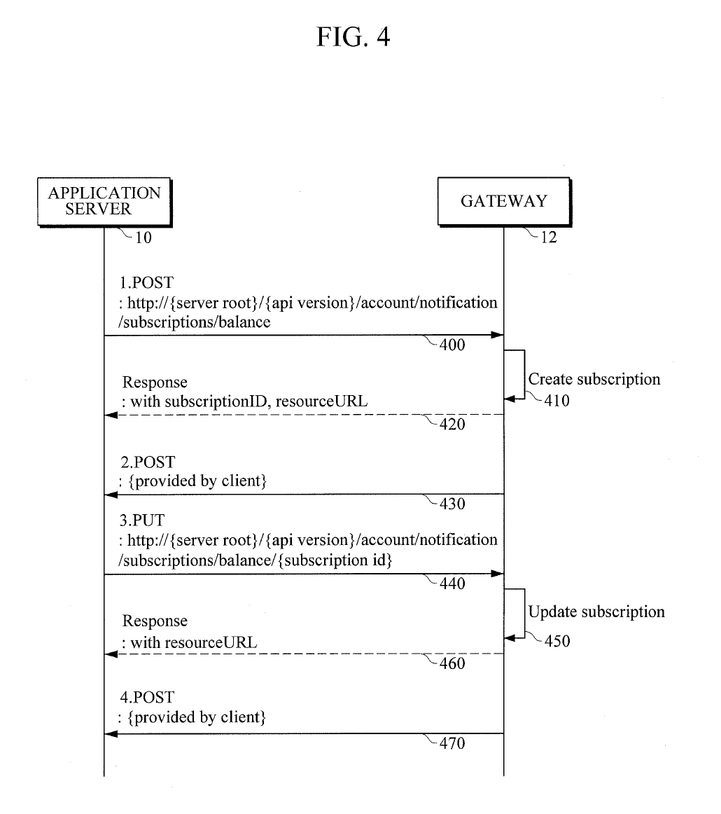

FIG. 4 illustrates an example of a method for account change notification between the open type service application server 10 and the open type service gateway 12 in a REST based environment.

As shown in FIG. 4, the application server 10 requests an account balance change notification subscription from the open type service gateway 12 by use of a POST method of an account balance change notification subscription resource. The open type service gateway 12 creates the account balance change notification subscription upon the request (410), and the application server 10 receives a result of the account balance change notification subscription having a subscription ID and a resource URL that are allocated by the open type service gateway 12 (420). If an account balance change occurs, the application server 10 receives a notification about the account balance change from the open type service gateway 12 by use of a POST method of the Client Notification Callback resource (430).

Thereafter, if subscription information needs to be updated according to different subscription IDs, the application server 10 requests the open type service gateway 12 to update the account balance change notification subscription by use of a PUT method of the Individual Account Balance change notification subscription resource (440). The open type service gateway 12 updates the account balance change notification subscription (450). The application server 10 receives a result of the update of the account balance change notification subscription having a resource URL from the open type service gateway 12 (460). If an account balance change occurs, the application server 10 receives a notification about the account balance change from the open type service gateway by use of a POST method of the Client Notification Callback resource (470).

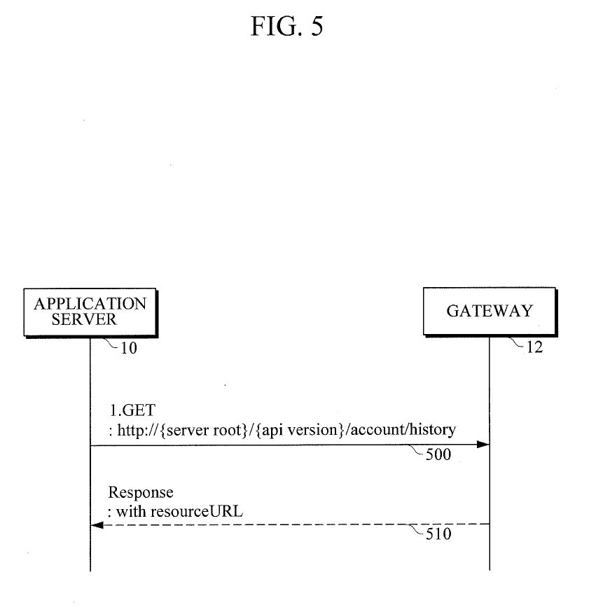

FIG. 5 illustrates an example of a method for account transaction history inquiry between the open type service application server and the open type service gateway in a REST based environment.

As shown in FIG. 5, the application server 10 requests the open type service gateway 12 to inquire into an account transaction history by use of a GET method of the account history resource (500). Thereafter, the application server 10 receives a result of the inquiry of the account transaction history having a resource ULR from the gateway 12.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A system for account management based on Represental State Transfer (REST), the system comprising:
an open type service application server configured to provide an interface with respect to a client that uses a RESTful web service, manage an access right of the client and call an account management open type interface from an open type service gateway;
the open type service gateway configured to provide the open type service application server with account management resources through a RESTful web service; and
a billing server configured to charge the RESTful web service while interoperating with the open type service gateway.

2. The system of claim 1, wherein the open type service gateway comprises:
a RESTful web service unit configured to process a REST message that is received from the open type service application server, transmit the processed REST message to an account management function unit and transmit a REST response message to the open type service application server; and
the account management function unit configured to operate an account management interface and an account management subscription and notification interface.

3. The system of claim 2, wherein the account management function unit comprises:
an account management function control unit configured to control an account management function processing unit and an account management function subscription and notification processing unit;
the account management function processing unit configured to operate an account management interface for account management and interoperate with the billing server; and
the account management function subscription and notification processing unit configured to operate an account management subscription and notification interface for account balance change and to interoperate with the billing server.

4. The system of claim 3, wherein the account management function control unit creates a Remote Method Invocation (RMI) server to process a RMI request made by the account management RESTful web service unit and registers the created RMI server in a RMI registry, and
upon a request by the account management RESTful web service unit, retrieves instances of the account management function processing unit and the account management function subscription and notification processing unit.

5. The system of claim 3, wherein the account management function processing unit is created by the RMI server of the account management function control unit, performs an operation of processing, returning and finishing one piece of information upon reception of one request, and interoperates with the billing server to perform account management.

6. The system of claim 3, wherein the account management function subscription and notification processing unit is created by the RMI server of the account management function control unit, performs an operation of processing, returning and finishing one piece of information upon reception of one request, and interoperates with the billing server to notify the open type service application server of a result of account management.

7. The system of claim 1, wherein the open type service gateway performs at least one of an account balance inquiry, an account balance update, an account balance change and an account transaction inquiry by use of the account management resource.

8. The system of claim 7, wherein upon a request by the open type service application server, the open type service gateway inquires into an account balance and an expiration data by use of a GET method of an account balance resource, provides a result of the inquiry to the open type service application server, updates an account balance by use of a PUT method of the account balance resource, and provides a result of the update to the open type service application server.

9. The system of claim 7, wherein upon a request by the open type service application server the open type service gateway creates a new account balance change notification subscription by use of a POST method of an account balance change notification subscription resource and provides a result of all account balance change notification subscription inquiries by use of a GET method of the account balance change notification subscription resource.

10. The system of claim 7, wherein the open type service gateway updates an account balance change notification subscription by use of a PUT method of an individual account balance change notification subscription resource and provides a result of an account balance change notification subscription inquiry by use of a GET method of the individual account balance change notification subscription resource.

11. The system of claim 7, wherein if an account balance is changed, the open type service gateway notifies the open type service application server of the change of the account balance by use of a POST method of a client notification callback resource.

12. The system of claim 7, wherein upon a request by the open type service application server, the open type service gateway provides the open type service application server with an account transaction history inquiry result by use of a GET method of an account transaction resource.

13. A system for account management based on Represental State Transfer (REST), the system comprising:
a RESTful web service client configured to manage an account balance by calling an account management resource of an open type service gateway, and if an account balance is changed, process an account subscription and notification by calling an account management subscription and notification resource of the open type service gateway;
a RESTful web service server configured to operate an account management interface and an account management subscription and notification interface of the open type service gateway; and
an interface configured to connect the open type service gateway to a billing server.

14. An account management method of an open type service application server that provides an interface with respect to a client that uses a RESTful web service, the account management method comprising:
calling, at the open type service application server, an account management open type interface from an open type service gateway and performing account management by use of account management resources.

15. The account management method of claim 14, wherein the performing of the account management comprises
requesting the open type service gateway to inquire into an account balance by use of a GET method of an account balance resource; and
receiving a result of the account balance inquiry having a resource URL (Uniform Resource Locator) from the open type service gateway.

16. The account management method of claim 15, further comprising:
requesting the open type service gateway to update the account balance by use of a PUT method of the account balance resource; and
receiving a result of the account balance update having a resource URL from the open type service gateway.

17. The account management method of claim 14, wherein the performing of the account management comprises
requesting an account balance change notification subscription from the open type service gateway by use of a POST method of an account balance change notification subscription resource; and
if the open type service gateway creates the account balance change notification subscription upon the request, receiving a result of the account balance change notification subscription having a subscription ID and a resource URL that are allocated by the open type service gateway.

18. The account management method of claim 17, further comprising:
if an account balance change occurs, receiving a notification about the account balance change from the open type service gateway by use of a POST method of a client notification callback resource.

19. The account management method of claim 17, further comprising:
requesting the open type service gateway to update the account balance change notification subscription by use of a PUT method of an individual account balance change notification subscription resource; and
receiving a result of the update of the account balance change notification subscription having a resource URL from the open type service gateway if the open type service gateway updates the account balance change notification subscription according to the request.

20. The account management method of claim 19, further comprising:
if an account balance change occurs, receiving a notification about the account balance change from the open type service gateway by use of a POST method of the client notification callback resource.

21. The account management method of claim 14, wherein the performing of the account management comprises
requesting the open type service gateway to inquire into an account transaction history by use of a GET method of an account transaction resource; and
receiving a result of the inquiry of the account transaction history having a resource ULR from the open type service gateway.
